(19) United States
(12) Patent Application Publication
(10) Pub. No.: US 2019/0361532 A1
(43) Pub. Date: Nov. 28, 2019

(54) 3D DISPLAY WITH GESTURE RECOGNITION AND DEPTH ADJUSTMENT FUNCTION

(71) Applicant: ACER INCORPORATED, New Taipei City (TW)

(72) Inventors: Chia-Yu Sun, New Taipei City (TW); Jin-Ting Kuo, New Taipei City (TW); Chao-Shih Huang, New Taipei City (TW)

(21) Appl. No.: 16/109,761

(22) Filed: Aug. 23, 2018

(30) Foreign Application Priority Data
May 28, 2018 (TW) 107118096

(51) Int. Cl. G06F 3/01; G06T 19/20

(52) U.S. Cl. CPC G06F 3/017; G06T 2219/2016; G06T 19/20

(57) ABSTRACT

A 3D display includes a screen, a depth detecting circuit, and a processing circuit. The depth detecting circuit includes multiple IR sensors. The processing circuit is configured to receive optical signals of the IR sensors for providing data captured within the scan regions of the depth detecting circuit, determine whether a gesture is detected according to the data captured within the scan regions of the depth detecting circuit, calculate the location of one or multiple centroids of the gesture, identify the distance variation between the gesture and the screen according to the mobility information of the one or multiple centroids, and instruct the screen which displays a 3D object to adjust the visual distance between the gesture and the screen, the size of the 3D object and the depth of the 3D object according to the distance variation.

### CROSS REFERENCE TO RELATED APPLICATION

This application claims priority of Taiwan Application No. 107118096 filed on May 28, 2018.

### BACKGROUND OF THE INVENTION

### 1. Field of the Invention

The present invention provides a 3D display with gesture recognition and depth adjustment function, and more particularly, to a low-cost, low-energy and small-sized 3D display with gesture recognition and depth adjustment function.

### 2. Description of the Prior Art

Triangulation-based long-range sensing techniques include microwave, acoustic wave, Infrared, laser and stereoscopy. The idea of providing a 3D display with gesture recognition function has been proposed, but implementing the above-mentioned long-range sensing techniques to achieve this does not result in a marketable product. The reason is that the camera sensing devices are bulky, expensive and consume a lot of energy, thus particularly unsuitable for laptop computers, desktop computers or portable electronic devices. Also, the display parameters (such as image depth) of a prior art 3D display do not change with gesture input, which makes the visual effect when interacting with gesture input unnatural.

Therefore, there is a need for a low-cost, low-energy and small-sized 3D display with gesture recognition and depth adjustment function.

### SUMMARY OF THE INVENTION

The present invention provides a 3D display with gesture recognition and depth adjustment function and including a screen for displaying a 3D object, a depth detecting circuit comprising multiple IR sensors, and a processing circuit. The processing circuit id configured to receive optical signals of the multiple IR sensors for providing data captured within scan regions of the multiple IR sensors, determine whether a gesture is detected according to the data captured within the scan regions of the multiple IR sensors, calculate a location of one or multiple centroids associated with the gesture, identify a distance variation between the gesture and the screen according to a mobility information of the one or multiple centroids, and instruct the screen to adjust at least one among a visual distance between the 3D object and the screen, a size of the 3D object and a depth of the 3D object according to the distance variation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a 3D display with gesture recognition and depth adjustment function according to an embodiment of the present invention.

FIG. 2 is a diagram illustrating a 3D display according to an embodiment of the present invention.

FIG. 3 is a diagram illustrating the operation of a depth detecting circuit according to an embodiment of the present invention.

FIGS. 4A˜4C are diagrams illustrating the operation of a depth detecting circuit according to an embodiment of the present invention.

FIGS. 5A˜5C are diagrams illustrating the operation of a depth detecting circuit according to an embodiment of the present invention.

FIGS. 6A and 6B are diagrams illustrating the operation of depth adjustment in response to a pull gesture or a push gesture according to embodiments of the present invention.

### DETAILED DESCRIPTION

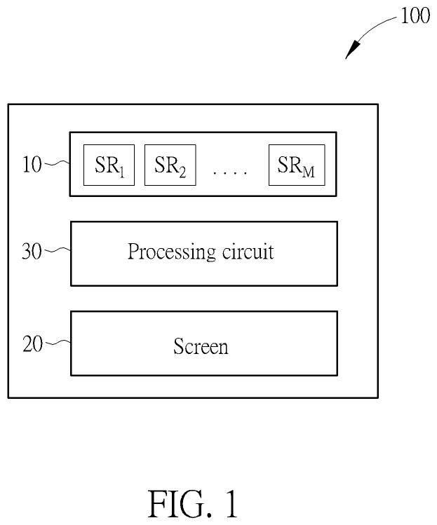

FIG. 1 is a functional diagram illustrating a 3D display 100 with gesture recognition and depth adjustment function according to an embodiment of the present invention. The 3D display 100 includes a depth detecting circuit 10, a screen 20, and a processing circuit 30. The depth detecting circuit 10 includes a plurality of infrared radiation (IR) sensors SR₁˜SR_{M}, wherein M is an integer larger than 1. The processing circuit 30 is configured to instruct the screen 20 to adjust the depth of a displayed object according to data captured within the scan region of the depth detecting circuit 10.

In an embodiment of the present invention, the screen 20 of the 3D display 100 includes a liquid crystal display (LCD) panel. The display region of the LCD panel includes pixels for displaying left-eye images and pixels for displaying right-eye images. A parallax barrier or a lenticular lens maybe disposed in front of the LCD panel for respectively projecting left-eye images and right-eye images to the left eye and the right eye of a viewer, thereby creating a sense of stereoscopy. The difference between a left-eye image and a corresponding right-eye image perceived by the viewer is called depth. In an embodiment of the present invention, transparent electrodes may be disposed on the top-side and the bottom-side of the LCD panel for changing the angle of LCD molecules, thereby adjusting the depth of an image. A larger difference between a left-eye image and a right-eye image (larger depth) perceived by the viewer results in higher stereoscopic contents, while a smaller difference between a left-eye image and a right-eye image (smaller depth) perceived by the viewer results in lower stereoscopic content. In other embodiment, the screen 20 may also be implemented using another suitable 3D display technique.

In an embodiment of the present invention, the processing circuit 30 may be implemented using a processor or an application-specific integrated circuit (ASIC). However, the implementation of the processing circuit 30 does not limit the scope of the present invention.

In an embodiment of the present invention, the 3D display 100 may be a laptop computer, a desktop computer, a TV, or any device with display function. The depth detecting circuit 10 may be disposed below the effective display range of the screen 20 so that the variation in the distance between a gesture and the screen 20 may be detected within the scan regions of the IR sensors SR₁˜SR_{M}. In an embodiment, the effective display range of the screen 20 maybe defined by the viewing range of the screen 20. That is, when positioned within the viewing range of the screen 20, the user can clearly (with predefined image quality, contrast, brightness variation and luminance variation) observe all display contents from different angles. However, the size of the effective display range of the screen 20 does not limit the scope of the present invention.

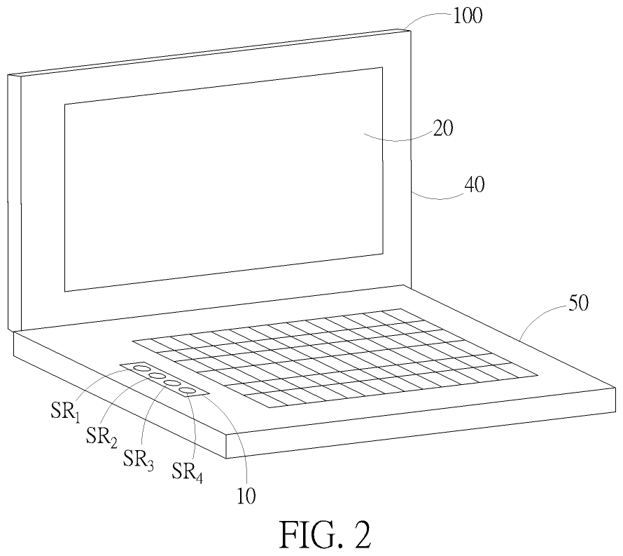

FIG. 2 is a diagram illustrating the 3D display 100 according to an embodiment of the present invention. In this embodiment, the 3D display 100 is a laptop computer, wherein the screen 20 is disposed on a cover 40, the depth detecting circuit 10 is disposed on a base housing 50, and the processing circuit 30 (not shown in FIG. 2) is disposed inside the base housing 50. The cover 40 is pivotally connected to one side of the base housing 50 so that the user can adjust the angle between the cover 40 and the base housing 50. However, the type of the 3D display 100 does not limit the scope of the present invention.

For illustrative purpose, FIG. 2 depicts the embodiment when M=4. However, the value of M does not limit the scope of the present invention. In the 3D display 100 depicted in FIG. 2, the cover 40 containing the screen 20 is located on a first side of the base housing 50, and the IR sensors SR₁˜SR₄ of the depth detecting circuit 10 are located on a second side of the base housing 50, wherein the first side and the second side are two opposite sides of the base housing 50.

The present 3D display 100 may provide depth adjustment function using time of flight (TOF) technique. The IR sensors of the depth detecting circuit 10 provide IR beams which illuminate an object and are then reflected back by the object. The distance of the object may be resolved based on the known speed of light, measuring the time-of-flight of an optical signal between a detecting circuit and the object for each point of the image.

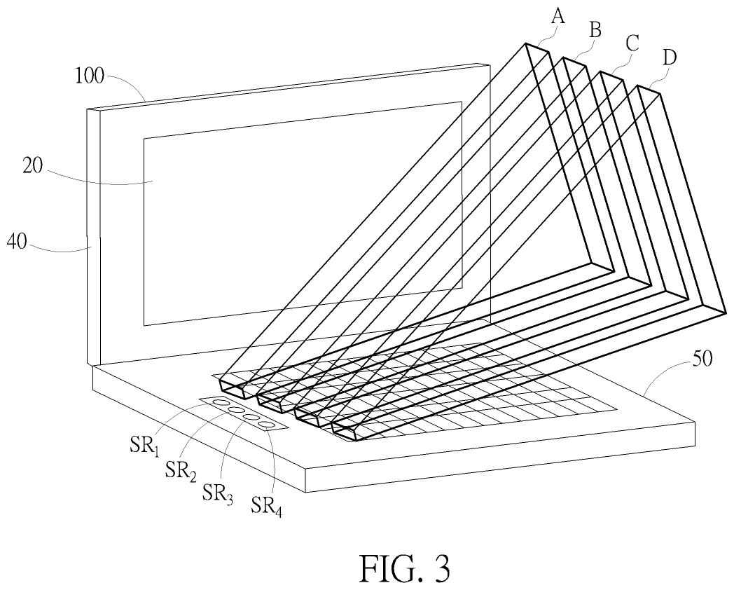

FIG. 3 is a diagram illustrating the operation of the depth detecting circuit 10 according to an embodiment of the present invention. The scan region A of the IR sensor SR₁, the scan region B of the IR sensor SR₂, the scan region C of the IR sensor SR₃, and the scan region D of the IR sensor SR₄ are pyramid-shaped regions in front of the screen 20. Therefore, the depth detecting circuit 10 is able to monitor gestures present in the effective display range of the monitor 20. However, the shapes of the scan regions A˜D do not limit the scope of the present invention.

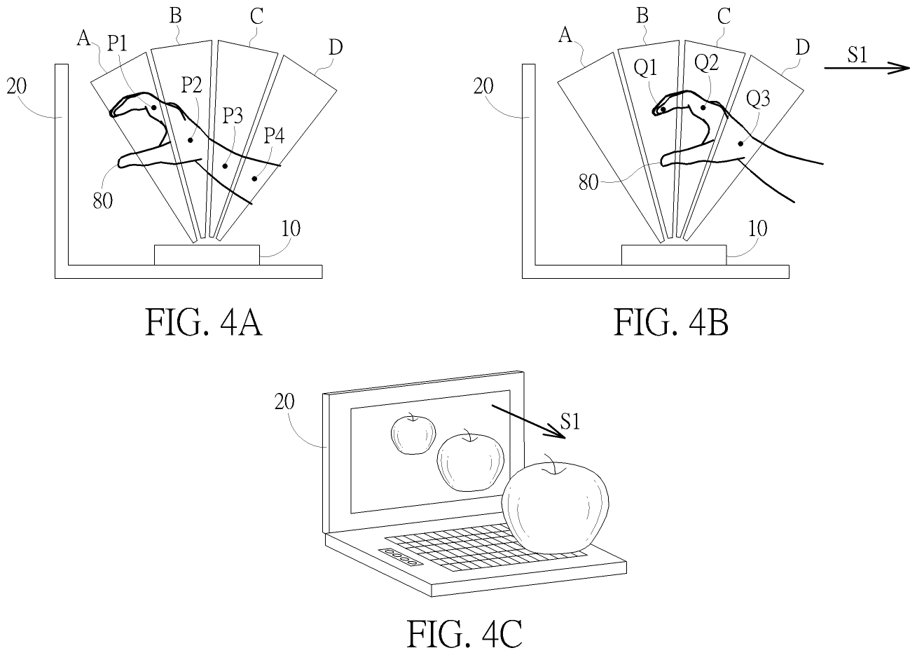

FIGS. 4A˜4C are diagrams illustrating the operation of the depth detecting circuit 10 according to an embodiment of the present invention. FIGS. 4A and 4B sequentially depict the process of a palm 80 of a user issuing a pull gesture. At a first point of time in the initial stage of the pull gesture depicted in FIG. 4A, it is assumed that the palm 80 appears in the scan regions A˜D and the depth detecting circuit 10 may detect 4 centroid coordinates P1˜P4 associated with the palm 80. At a second point of time in the final stage of the pull gesture depicted in FIG. 4B, it is assumed that the palm 80 appears in the scan regions B˜D and the depth detecting circuit 10 may detect 3 centroid coordinates Q1˜Q3 associated with the palm 80. According to the difference between the first point of time and the second point of time as well as the location changes of the coordinates P1˜P4 and Q1˜Q3, the processing circuit 30 may determine the moving direction of each centroid, wherein each centroid or most centroids move away from the screen 20, as depicted by the arrow S1 (pointing towards the user) in FIG. 4B. According to the moving direction of each centroid, the processing circuit 30 may determine that the palm 80 is issuing the pull gesture, thereby instructing the screen 20 to display a 3D object in a way indicated by the pull gesture. As depicted in FIG. 4C, since the displayed 3D object moves towards to user in response to the pull gesture, the user may perceive an increase in the visual distance between the 3D object and the screen 20 and an increase in the size of the 3D object.

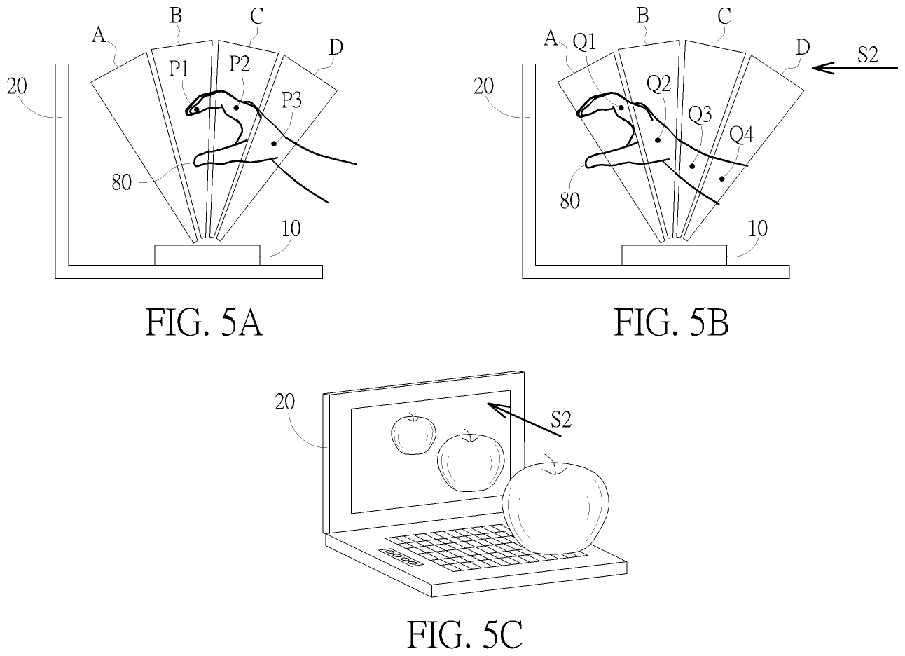

FIGS. 5A˜5C are diagrams illustrating the operation of the depth detecting circuit 10 according to an embodiment of the present invention. FIGS. 5A and 5B sequentially depict the process of a palm 80 of a user issuing a push gesture. At a third point of time in the initial stage of the push gesture depicted in FIG. 5A, it is assumed that the palm 80 appears in the scan regions B˜D and the depth detecting circuit 10 may detect 3 centroid coordinates P1˜P3 associated with the palm 80. At a fourth point of time in the final stage of the push gesture depicted in FIG. 5B, it is assumed that the palm 80 appears in the scan regions A˜D and the depth detecting circuit 10 may detect 4 centroid coordinates Q1˜Q4 associated with the palm 80. According to the difference between the third point of time and the fourth point of time as well as the location changes of the coordinates P1˜P3 and Q1˜Q4, the processing circuit 30 may determine the moving direction of each centroid, wherein each centroid or most centroids move towards the screen 20, as depicted by the arrow S2 (pointing away from the user) in FIG. 5B. According to the moving direction of each centroid, the processing circuit 30 may determine that the palm 80 is issuing the push gesture, thereby instructing the screen 20 to display a 3D object in a way indicated by the push gesture. As depicted in FIG. 5C, since the displayed 3D object moves away from the user in response to the push gesture, the user may perceive a decrease in the visual distance between the 3D object and the screen 20 and a decrease in the size of the 3D object.

In the embodiments illustrated in FIGS. 4A˜4C and 5A˜5C, the centroid coordinates may be generated by the depth detecting circuit 10 based on the signals detected by the depth detecting circuit 10. In another embodiment, the signals detected by the depth detecting circuit 10 may be sent to the processing circuit 30, which thus generates the centroid coordinates accordingly.

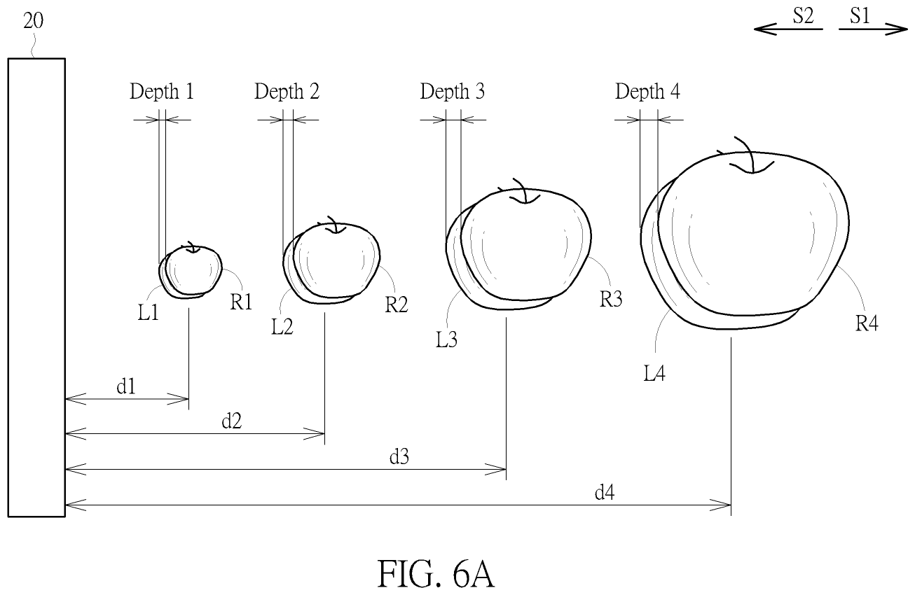

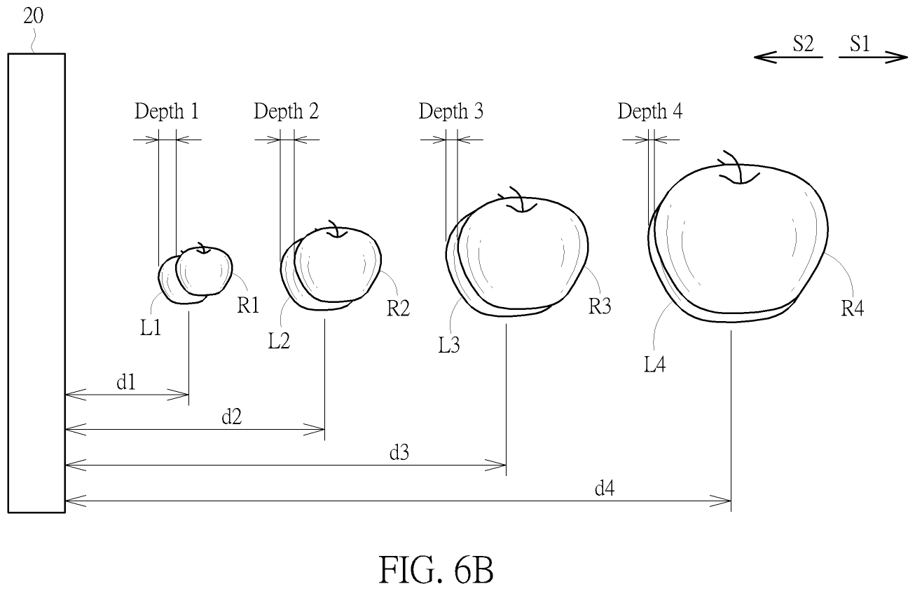

FIGS. 6A and 6B are diagrams illustrating the operation of depth adjustment in response to a pull gesture or a push gesture according to embodiments of the present invention. L1˜L4 represent left-eye images when the visual distances between the screen 20 and its displayed object are d1˜d4, respectively. R1˜R4 represent right-eye images when the visual distances between the screen 20 and its displayed object are d1˜d4, respectively. Depth 1 represents the depth of the left-eye image L1 and the right-eye image R1. Depth 2 represents the depth of the left-eye image L2 and the right-eye image R2. Depth 3 represents the depth of the left-eye image L3 and the right-eye image R3. Depth 4 represents the depth of the left-eye image L4 and the right-eye image R4. The direction of the arrow S1 corresponds to the process of the screen 20 changing its displayed object in response to the pull gesture. The direction of the arrow S2 corresponds to the process of the screen 20 changing its displayed object in response to the push gesture.

Due to different visual preferences of different users, when the visual distances between the screen 20 and its displayed object are d1˜d4, the values of the corresponding depths Depth 1˜Depth 4 maybe determined according to the size of the screen 20, the structure of the displayed object, the background luminance and the age of the user. For example in FIGS. 6A and 5B, as the displayed object moves away from the screen 20 and approaches the user, the screen 20 may increase the sizes of the corresponding left-eye images and right-eye images (R4>R3>R2>R1 and L4>L3>L2>L1). In the embodiment depicted in FIG. 6A, as the displayed object moves away from the screen 20 and approaches the user, the screen 20 may increase the depths of the corresponding left-eye images and right-eye images (Depth 4>Depth 3>Depth 2>Depth 1). In the embodiment depicted in FIG. 6B, as the displayed object moves away from the screen 20 and approaches the user, the screen 20 may decrease the depths of the corresponding left-eye images and right-eye images (Depth 4<Depth 3<Depth 2<Depth 1). However, the gradual depth adjustments depicted in FIGS. 6A and 6B are merely for illustrative purpose, but does not limit the scope of the present invention. In another embodiment, Depth 1˜Depth 4 associated with d1˜d4 may be set to have the same value due to user preference.

In the above-mentioned embodiments, the depth detecting circuit 10 and the screen 20 may be respectively disposed on two adjacent sides of the base housing 50, and the layout of the IR sensors SR₁˜SR_{M} in the depth detecting circuit 10 may be arranged so that a gesture moving in a direction perpendicular to the surface of the screen 20 may be detected with in the scan regions of the IR sensors SR₁˜SR_{M}, thereby adjusting the visual distance between a 3D object and the screen 20, the size of the 3D object and the depth of the 3D object accordingly. In another embodiment, the depth detecting circuit 10 maybe disposed another appreciate location, and the layout of the IR sensors SR₁˜SR_{M} in the depth detecting circuit 10 may be arranged so that a gesture moving in a direction perpendicular to the surface of the screen 20 may be detected with in the scan regions of the IR sensors SR₁˜SR_{M}, thereby adjusting the visual distance between a 3D object and the screen 20, the size of the 3D object and the depth of the 3D object accordingly.

In conclusion, the present 3D display adopts low-cost, low-energy and small-sized IR sensors for detecting the distance between a gesture and a screen. The visual distance between a 3D object and the screen, the size of the 3D object and the depth of the 3D object may be adjusted in response to the gesture so as to provide natural 3D visual effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A 3D display with gesture recognition and depth adjustment function, comprising:
a screen for displaying a 3D object;
a depth detecting circuit comprising multiple infrared radiation (IR) sensors; and
a processing circuit configured to:
receive optical signals of the multiple IR sensors for providing data captured within scan regions of the multiple IR sensors;
determine whether a gesture is detected according to the data captured within the scan regions of the multiple IR sensors;
calculate a location of one or multiple centroids associated with the gesture;
identify a distance variation between the gesture and the screen according to a mobility information of the one or multiple centroids; and
instruct the screen to adjust at least one among a visual distance between the 3D object and the screen, a size of the 3D object and a depth of the 3D object according to the distance variation.

2. The 3D display of claim 1, wherein the scan regions of the multiple IR sensors do not intersect with each other.

3. The 3D display of claim 1, wherein the scan regions of the multiple IR sensors are multiple pyramid-shaped regions in front of the screen.

4. The 3D display of claim 1, wherein the processing circuit is further configured to:
determine moving directions of a first centroid and a second centroid associated with the gesture according to locations of the first centroid and the second centroid; and
determine that the gesture is a pull gesture when a distance between the first centroid and the second centroid remains unchanged, the first centroid moves away from the screen and the second centroid moves away from the screen.

5. The 3D display of claim 4, wherein:
the processing circuit is further configured to instruct the screen to adjust the visual distance between the 3D object and the screen from a first value to a second value, adjust the size of the 3D object from a third value to a fourth value, and adjust the depth of the 3D object from a fifth value to a sixth value when determining that the gesture is the pull gesture;
the first value is smaller than the second value;
the third value is smaller than the fourth value; and
the fifth value is different from the sixth value.

6. The 3D display of claim 1, wherein the processing circuit is further configured to:
determine moving directions of a first centroid and a second centroid associated with the gesture according to locations of the first centroid and the second centroid; and
determine that the gesture is a push gesture when a distance between the first centroid and the second centroid remains unchanged, the first centroid moves towards from the screen and the second centroid moves towards the screen.

7. The 3D display of claim 6, wherein:
the processing circuit is further configured to instruct the screen to adjust the visual distance between the 3D object and the screen from a first value to a second value, adjust the size of the 3D object from a third value to a fourth value, and adjust the depth of the 3D object from a fifth value to a sixth value when determining that the gesture is the push gesture;
the first value is larger than the second value;
the third value is larger than the fourth value; and
the fifth value is different from the sixth value.

8. The 3D display of claim 1, wherein:
the screen is disposed on a cover;
the depth detecting circuit is disposed on a first side of a base housing;
the processing circuit is disposed inside the base housing;
the cover is pivotally connected to a second side of the base housing; and
the first side and the second side are two opposite sides of the base housing.

9. The 3D display of claim 1, wherein the depth detecting circuit is disposed below an effective display range of the screen.
